(19) United States
(12) Patent Application Publication
(10) Pub. No.: US 2024/0207776 A1
(43) Pub. Date: Jun. 27, 2024

(54) AUTOMATED SYSTEMS AND PROCESSES FOR MAINTAINING A BOTTOMS LIQUID LEVEL OF A REGENERATOR IN A GIRBOTOL PROCESS

(71) Applicant: Saudi Arabian Oil Company, Dhahran (SA)

(72) Inventors: Zaid Alkhunaizi, Qatif (SA); Abdullah Al-Abbad, Al-Omran (SA); Jafar Al-Yaseen, Dammam (SA)

(73) Assignee: Saudi Arabian Oil Company, Dhahran (SA)

(21) Appl. No.: 18/145,291

(22) Filed: Dec. 22, 2022

(51) Int. Cl. B01D 53/14

(52) U.S. Cl. CPC B01D 53/1425; B01D 53/1468; B01D 53/1475; B01D 53/1493; B01D 2252/204; B01D 2257/304; B01D 2257/504; B01D 2311/16

(57) ABSTRACT

An automated system for maintaining a bottoms liquid level of a regenerator includes a Girbotol process including an amine absorption unit with a control valve, a flash drum, the regenerator, and a reflux drum. The automated system also includes a controller communicatively coupled to the Girbotol process and operable to execute a process with the control valve, the process including: monitoring flow rates of the streams of the Girbotol process; observing a change in the flow rates of the streams; calculating an expected change in a bottoms liquid volume of the regenerator based on the change in the flow rate of the streams; determining a first expected change in the make-up water stream's flow rate needed to offset the expected change; and adjusting a make-up water stream's flow rate through the control valve, based on the first expected change.

### TECHNICAL FIELD

The present disclosure relates to processes and systems for sweetening an acid gas feed, and more specifically to automated systems and processes for maintaining a bottoms liquid level of a regenerator in a Girbotol process.

### BACKGROUND

The presence of corrosive species such as hydrogen sulfide, carbon dioxide, organic acids, and brine solutions in produced hydrocarbons can create an aggressively corrosive environment for transportation pipelines and hydrocarbon processing facilities in the oil and gas industry. Once dissolved in water, both CO₂ and H₂S behave like weak acids and can cause oxidation, which promotes steel corrosion. This corrosion can cause severe damage on the internal walls of production and transportation pipelines, which are mostly steel-based materials. Corrosion leads to many risks, such as pipeline leakages and even bursting, resulting in unplanned turnaround maintenance time and costs. Generally, hydrocarbons containing these corrosive species may be commonly referred to as ‘acid gases’ or ‘sour’, whereas the same hydrocarbons without the corrosive species or the after removal of the same are referred to as ‘sweet’.

### SUMMARY

Accordingly, it may be desired to remove these corrosive species from produced hydrocarbons to avoid potential corrosion problems, as well as to increase the economic value of the hydrocarbons. Amine gas treating, also known as amine scrubbing, gas sweetening, or acid gas removal, is a well-known process that uses aqueous solutions of various amines to remove the above corrosive species from produced hydrocarbons, such as acid gas or sour gas streams.

One well-known example of amine gas treating is the Girbotol process, in which an acid gas feed is initially fed to an absorber column with the aqueous amines, in the form of a lean amine stream, to generate a sweet gas stream and a sour effluent stream including the corrosive species absorbed to the aqueous amines. The sour effluent stream then enters a regenerator (which may also be referred to as a stripper column) which strips the corrosive species from the down-flowing sour effluent stream using an up-flowing steam stream, thereby generating an aqueous amine stream of relatively lesser acid gas content in the bottom of the regenerator and a stripped gas stream of relatively greater acid gas content (the separated corrosive species) at the top of the regenerator. The aqueous amine stream of relatively lesser acid gas content (lean amine stream) may then be reused in the absorber column. Additionally, amine recirculation efficiency within the system may be further optimized by adding a makeup water stream to the top of the absorbing unit, through which the sweet gas stream exits. The makeup water stream may ‘water wash’ the sweet gas stream, removing at least a portion of the entrained amines within the same and increasing the amount of amine available for recirculation within the system.

However, the addition of the excess water from the make-up water stream may also negatively impact other units within the Girbotol process, such as by varying the bottoms liquid volume, and thus the bottoms liquids level, of the regenerator 110. This variation in the bottoms liquid level can also impact other parameters to which the bottoms liquid level is related, such as the stripping efficiency of the regenerator as well as the concentration of amines within the lean amine stream.

Accordingly, processes of controlling a bottoms liquid level of the regenerator are desired. Further, these processes should ideally control the bottoms liquid level through control of the rates of the streams entering and leaving the regenerator, rather than the bottoms liquids level or bottoms liquid volume directly, so as to maximize the amount of amine recirculating within the system.

Consequently, systems and process herein allow the control of the bottoms liquid level of the regenerator by controlling the flow-rate of the make-up water stream. Further, the systems and processes herein incorporate a ‘feed-forward logic’ that correlates changes in the flow rates of each of the streams in the system to a change in the bottoms liquid level, then calculates and adjusts to the expected change in the make-up water stream needed to maintain the previous bottoms liquid level. This allows the systems and processes to react to changes in the bottoms liquid level before they occur, advantageous due to the distance between the make-up water stream and the regenerator, as compared to the relatively shorter distance from the other streams to and from the same.

Further, the systems and processes also includes a ‘feed-back logic’ that records the actual change in the bottoms liquid level after the change in the make-up stream reaches the regenerator. The ‘feed-back logic’ then predicts a change needed in the make-up water stream to ‘fine-tune’ the current bottoms liquid level to the original bottoms liquid level and adjusts the make-up water stream to that change. Accordingly, systems and processes supra limit the changes to the bottoms liquid level of a regenerator in the Girbotol process, thereby optimizing amine recirculation as well as acid gas removal in the same.

In accordance with one embodiment herein, an automated system for maintaining a bottoms liquid level of a regenerator includes a Girbotol process, the Girbotol process including an amine absorption unit with a control valve, a flash drum, the regenerator, and a reflux drum. The automated system also includes a controller communicatively coupled to the Girbotol process and operable to execute a process with the control valve, the process including: monitoring flow rates of the streams of the Girbotol process; observing a change in the flow rates of the streams; calculating an expected change in a bottoms liquid volume of the regenerator based on the change in the flow rate of the streams; determining a first expected change in a make-up water stream's flow rate needed to offset the expected change; and adjusting the make-up water stream's flow rate through the control valve, based on the first expected change.

In accordance with another embodiment herein, an automated for maintaining a bottoms liquid volume of a regenerator includes monitoring flow rates of streams of a Girbotol process; observing a change in the flow rates of the streams; calculating an expected change in a bottoms liquid volume of a regenerator of the Girbotol process based on the change in the flow rate of the streams; stream's determining a first expected change in a make-up water flow rate needed to offset the expected change; and adjusting the make-up water stream's flow rate through the control valve, based on the first expected change

Additional features and advantages of the described embodiments will be set forth in the detailed description, which follows, and in part will be readily apparent to those skilled in the art from that description or recognized by practicing the described embodiments, including the detailed description, which follows, as well as the claims.

### BRIEF DESCRIPTION OF THE DRAWINGS

The following detailed description of specific embodiments of the present disclosure can be best understood when read in conjunction with the following drawings in which:

FIG. 1 illustrates a process flow diagram for an exemplary process in accordance with embodiments herein.

FIG. 2 illustrates a process flow diagram for an exemplary process in accordance with embodiments herein.

FIG. 3 illustrates a graph of the recorded bottoms liquid level of a regenerator over the timeframe of a year for an exemplary Girbotol process not including the processes or systems herein.

FIG. 4 illustrates a graph of the deviation from the normal bottoms liquid volume of the regenerator of FIG. 3 over the same year timeframe, measured in gallons for each day.

FIG. 5 illustrates a graph of the absolute percentage difference in amine concentration, as compared to the normal amine concentration, of the bottoms liquid volume of the regenerator of FIGS. 3 and 4 over the same year timeframe.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. Accompanying components that are in hydrotreating units, such as bleed streams, spent catalyst discharge subsystems, and catalyst replacement sub-systems are also not shown. It should be understood that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines, which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows, which do not connect two or more system components, signify a product stream, which exits the depicted system, or a system inlet stream, which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in embodiments, less than all of the stream signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation unit, or other system component. For example, it should be understood that when two streams are depicted as being combined directly prior to entering a separation unit or reactor, that in embodiments the streams could equivalently be introduced into the separation unit or reactor and be mixed in the reactor. Alternatively, when two streams are depicted to independently enter a system component, they may in embodiments be mixed together before entering that system component.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

As used herein, a “bottoms liquid level” may refer to the level in a reactor or unit below which the liquid resides. Accordingly, a “bottoms liquid volume” may refer to the volume of liquid residing below the bottoms liquid level in the reactor or unit.

As used herein, the term “C #hydrocarbons”, wherein “#” is a positive integer, is meant to describe all hydrocarbons having #carbon atoms. Moreover, the term “C #+ hydrocarbons” is meant to describe all hydrocarbon molecules having # or more carbon atoms. Accordingly, the term C₂₊ hydrocarbons” is meant to describe a mixture of hydrocarbons having 2 or more carbon atoms. The term “C₂₊ alkanes” accordingly relates to alkanes having 2 or more carbon atoms. The term “C₁-C₈ hydrocarbons” is meant to describe a mixture of hydrocarbons having between 1 and 8 carbon atoms.

It should be understood that an “effluent” generally refers to a stream that exits a system component such as a separation unit, a reactor, or reaction zone, following a particular reaction or separation, and generally has a different composition (at least proportionally) than the stream that entered the separation unit, reactor, or reaction zone.

As used herein, a “reactor” refers to a vessel in which one or more chemical reactions may occur between one or more reactants optionally in the presence of one or more catalysts. For example, a reactor may include a tank or tubular reactor configured to operate as a batch reactor, a continuous stirred-tank reactor (CSTR), or a plug flow reactor. Exemplary reactors include packed bed reactors such as fixed-bed reactors, and fluidized bed reactors. One or more “reaction zones” may be disposed in a reactor. As used herein, a “reaction zone” refers to an area where a particular reaction takes place in a reactor. For example, a packed bed reactor with multiple catalyst beds may have multiple reaction zones, where each reaction zone is defined by the area of each catalyst bed.

As used herein, a “separation unit” or “separator” refers to any separation device that at least partially separates one or more chemicals that are mixed in a process stream from one another. For example, a separation unit may selectively separate differing chemical species, phases, or sized material from one another, forming one or more chemical fractions. Examples of separation units include, without limitation, distillation columns, flash drums, knock-out drums, knock-out pots, centrifuges, cyclones, filtration devices, traps, scrubbers, expansion devices, membranes, solvent extraction devices, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation. As used herein, one or more chemical constituents may be “separated” from a process stream to form a new process stream. Generally, a process stream may enter a separation unit and be divided, or separated, into two or more process streams of desired composition. Further, in some separation processes, a “lower boiling point fraction” (sometimes referred to as a “light fraction” or “light fraction stream”) and a “higher boiling point fraction” (sometimes referred to as a “heavy fraction,” “heavy hydrocarbon fraction,” or “heavy hydrocarbon fraction stream”) may exit the separation unit, where, on average, the contents of the lower boiling point fraction stream have a lower boiling point than the higher boiling point fraction stream. Other streams may fall between the lower boiling point fraction and the higher boiling point fraction, such as a “medium boiling point fraction.”

It should further be understood that streams may be named for the components of the stream, and the component for which the stream is named may be the major component of the stream (such as comprising from 50 weight percent (wt. %), from 70 wt. %, from 90 wt. %, from 95 wt. %, from 99 wt. %, from 99.5 wt. %, or even from 99.9 wt. % of the contents of the stream to 100 wt. % of the contents of the stream). It should also be understood that components of a stream are disclosed as passing from one system component to another when a stream comprising that component is disclosed as passing from that system component to another. By way of non-limiting example, a referenced “C₂-C₄ hydrocarbon stream” passing from a first system component to a second system component should be understood to equivalently disclose “C₂-C₄ hydrocarbons” passing from a first system component to a second system component, and the like.

As previously stated, embodiments herein are directed to an automated system for maintaining a bottoms liquid level of a regenerator in a Girbotol process, as described infra. Embodiments herein are also directed to automated processes for maintaining the bottoms liquid level of the regenerator in the Girbotol process as described infra.

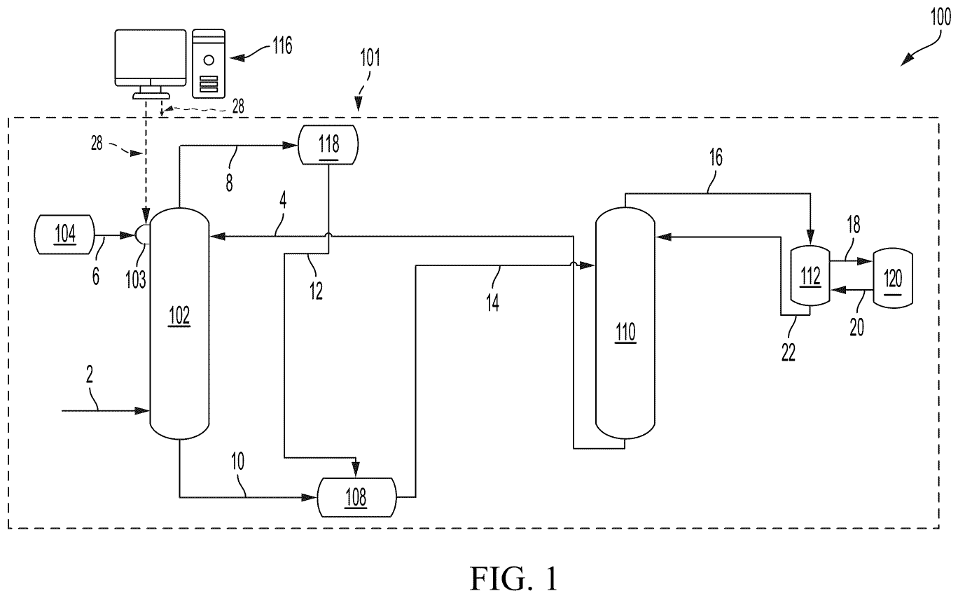

Referring initially to FIG. 1, an automated system 100 for maintaining the bottoms liquid level of the regenerator in the Girbotol process is illustrated. As previously described, the automated system 100 includes a controller 116 and a Girbotol process 101, which itself may include an amine absorption unit 102, a flash drum 108, the regenerator 110, and a reflux drum 112.

The amine absorption unit 102 may be configured to process an acid gas stream 2, a make-up water stream 6, and a lean amine stream 4. The acid gas stream 2 may include a hydrocarbon component and an acid gas component, the acid gas component including hydrogen sulfide, carbon dioxide, or any gas that may render a neutral pH aqueous solution acidic when dissolved within. The hydrocarbon component may include any hydrocarbon that may occur as a gas at atmospheric conditions. The acid gas stream 2 may include a relatively large amount of the acid gas component, such as from 1 wt. % to 99 wt. % acid gas component, measured by the weight of the acid gas stream. The acid gas stream 2, as used herein, may also be referred to herein as a “sour gas stream” such as in those situations in which the acid gas stream includes a relatively large amount of hydrogen sulfide as the acid gas component, as may be understood in the art. The lean amine stream 4 may include amines in an aqueous solution, the amine including diethanoloamine, monoethanoloamine, methyldiethanolamine, diisopropanolamine, aminoethoxyethanol, or any other amine known in the art.

Still referring to FIG. 1, the Girbotol process may further include a water source 104. The water source 104 may be fluidly connected to and upstream of the amine absorption unit. The water source 104 may be fluidly connected to the amine absorption unit 102 at a control valve 103, which may be coupled to the amine absorption unit 102. In other words, the water source 104 may be configured to supply the make-up water stream 6 to the amine absorption unit 102 through the control valve 103. The control valve 103, may in turn control the flow rate of the make-up water stream 6, such as through a differential pressure, by opening or closing the control valve 103, as may be understood in the art.

Particularly, water source 104 may supply the make-up water stream 6 to the top of the amine absorption unit 102 through the control valve 103, wherein the make-up water stream 6 may ‘water wash’ the sweet gas stream, thereby absorbing entrained amines from the lean amine stream 4 present in the sweet gas stream. Without being limited by theory, this may operate to remove amines in the sweet gas stream and increase the amount of amines recirculating within the Girbotol process 101.

For example, and in embodiments, the amine absorption unit 102 may further include an amine absorption section and a water washing section. The water washing section may be in fluid communication with and disposed above the amine absorption section. The control valve 103 may be coupled and fluidly connected to the aforementioned water washing section. The amine absorption section may be configured to process the acid gas stream 2 with the lean amine stream 4 to generate the rich amine stream 10 and the sweet gas stream including amines entrained in the same. The water washing section in turn may be configured to expose the sweet gas stream to the make-up water stream 6 to form a water washed sweet gas stream 8 and a water washed amine stream, the water washed amine stream of which may add to the water content and thereby the volume of the rich amine stream 10.

In embodiments, the sweet gas stream may include from 0.1 wt. % to 2 wt. % amines measured by weight of the sweet gas stream. The water washed sweet gas stream 8 may include from 0.001 wt. % amines to 1 wt. % amines measured by weight of the water washed sweet gas stream 8. In other words, the water washed sweet gas stream 8 may include a relatively lesser amount of amines than the sweet gas stream, which, without being limited by theory, may be attributable to the water washing.

Still referring to FIG. 1, the Girbotol process 101 may further include the flash drum 108. The flash drum 108 may be fluidly connected to and downstream from the amine absorption unit 102 and may be configured to accept the rich amine stream 10 and a compression return stream 12. The flash drum 108 may additionally be configured to process the rich amine stream 10 and the compression return stream 12 to form a flashed rich amine stream 14. Without being limited by theory, the inclusion of the flash drum 108 in the Girbotol process 101 may operate to increase the efficiency of the regenerator 110 by reducing the pressure of the rich amine stream 14 and the compression return stream 12. Moreover, the flash drum 108 may also separate hydrocarbon gases entrained in the rich amine stream 10 originating from the acid gas stream 2, further increasing the yield of saleable hydrocarbon gases within the Girbotol process 101.

Without being limited by theory, the compression return stream 12 may originate from further processing of the water washed sweet gas stream 8. Particularly, hydrocarbon gas may be scrubbed in a scrubber unit 118 (as may be understood in the art) from the water washed sweet gas stream 8, leaving an aqueous stream including any of the entrained amines not removed in the water washing process, this aqueous stream being the compression return stream 12. Without being limited by theory, the scrubbing of the water washed sweet gas stream 8 and the recycling of the compression return stream 12 may further increase the amount of recirculating amines contained within the Girbotol system 101.

The Girbotol process 101 may also include a regenerator 110, which as previously discussed may also be referred to as a stripper column. The regenerator 110 may be fluidly connected to and downstream from the flash drum 108, as well as being fluidly connected to and upstream of the amine absorption unit 102. The regenerator 110 may be configured to process the flashed rich amine stream 14 and a reflux drum effluent stream 22 to form the lean amine stream 4 and an stripped acid gas stream 16.

In embodiments, the flashed rich amine stream 14 and the reflux drum effluent stream 22 may enter through a top half of the regenerator 110. The flashed rich amine stream 14 and the reflux drum effluent stream 22 may then pass in a down-flow manner through the regenerator 110, contacting an up-flow steam stream. The up-flow steam stream may operate to strip at least a portion of the acid gas component from the rich amine stream 14 to form the stripped acid gas stream 16. The remaining portions of the flashed rich amine stream 14 and the reflux drum effluent stream 22 may then settle in a bottom half of the regenerator 110, the height and volume of which may be observed as the bottoms liquid level of the regenerator.

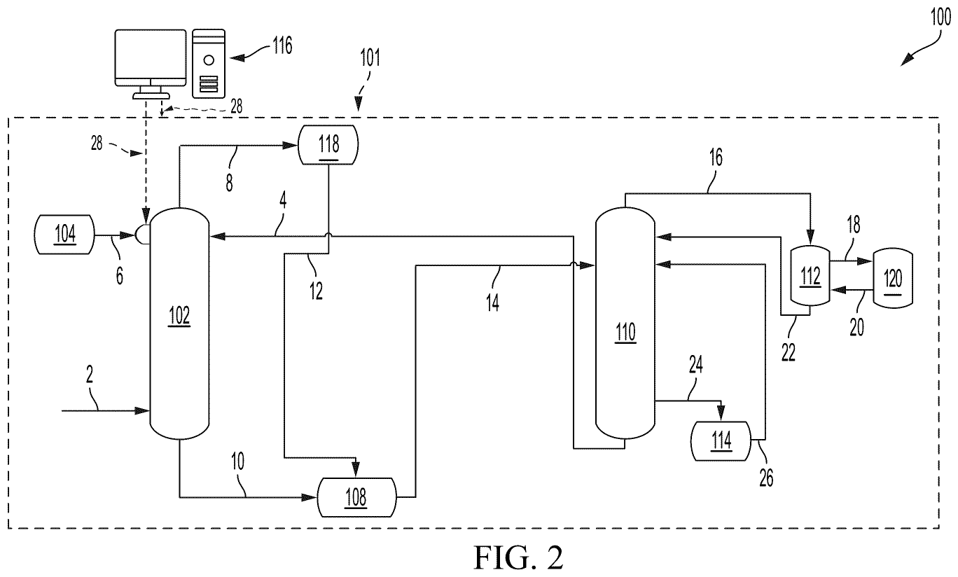

Now referring to FIG. 2, and in embodiments, the Girbotol process 101 may also include a re-boiler unit 114 fluidly connected to the regenerator 110. The regenerator may be additionally configured to send a regenerator effluent stream 24 to the re-boiler unit 114. The regenerator effluent stream 24 may be obtained from the settled remaining portions of the flashed rich amine stream 14 and the reflux drum effluent stream 22 at the bottoms liquid level. The re-boiler unit 114 may be configured to supply energy in the form of heat to the regenerator effluent stream 24 to form a water vapor stream 26. The re-boiler unit 114 may be further configured to send the water vapor stream 26 back to the regenerator 110, which may operate to form the up-flowing steam stream comprising the water vapor stream 26 within the regenerator 110. The up-flowing steam stream may then contact the flashed rich amine stream 14, the reflux drum effluent stream 22, or both, as previously described, thereby stripping at least a portion of the acid gas component from the previous and forming additional stripped acid gas stream 16 and lean amine stream 4.

Referring to FIGS. 1-2, the Girbotol process 101 may also include the reflux drum 112, which may be fluidly connected to the regenerator 110. The reflux drum 112 may be configured to process the stripped acid gas stream 16 and a sour water stream 20 to form an acid gas concentrate stream 18 and the reflux drum effluent stream 22. Without being limited by theory, and similar to the compression return stream 12, the sour water stream may originate from further processing of the acid gas concentrate stream 18. Particularly, at least a portion of the carbon dioxide and hydrogen sulfide may be scrubbed from the acid gas concentrate stream 18 in a scrubbing unit 120, (as may be understood in the art) resulting in an aqueous stream with a relatively lesser content of the acid gases, which may be the sour water stream 20. Without being limited by theory, the recycling of the sour water stream 20 to the regenerator 110 may reduce the amount of water exiting the Girbotol process 101 and thus the amount of make-up water needed to operate the same.

Still referring to FIGS. 1-2, the automated system 100 may further include the controller 116. The controller 116 may include a computer processor and may be communicatively coupled 28 to the Girbotol process 101. For example, and in embodiments, the controller 116 may be operable to control the degree to which the control valve 103 is open or closed, and thereby control the make-up water stream 6's flow rate through the control valve such as through a differential pressure from the water source 104 to the amine absorption unit 102.

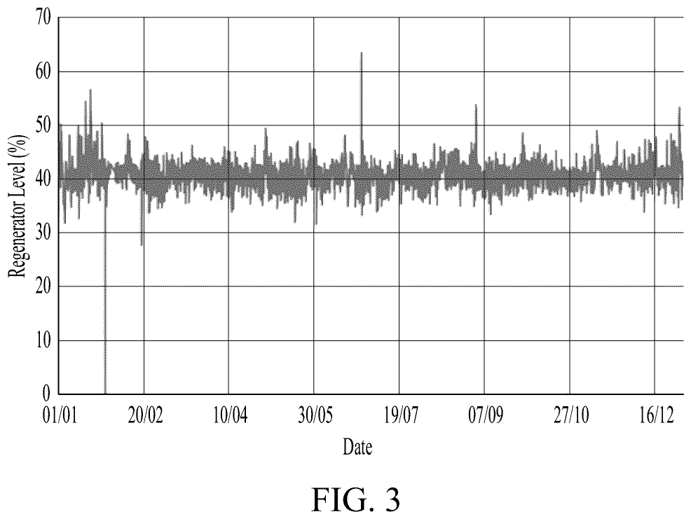

As previously mentioned, the addition of the make-up water stream 6 may benefit the Girbotol process 101 by generally increasing the amount of amine circulating within the Girbotol process 101. However, the addition of the additional water from the make-up water stream 6 may also negatively impact other units within the Girbotol process, such as by varying the bottoms liquid level of the regenerator 110. This is illustrated for example in FIG. 3, which shows the recorded level of a regenerator in operation in a Girbotol process over the course of a calendar year. This variation in the bottoms liquid level can also impact other parameters to which the bottoms liquid level is related, such as the stripping efficiency of the regenerator 110 as well as the concentration of amines within the lean amine stream 4.

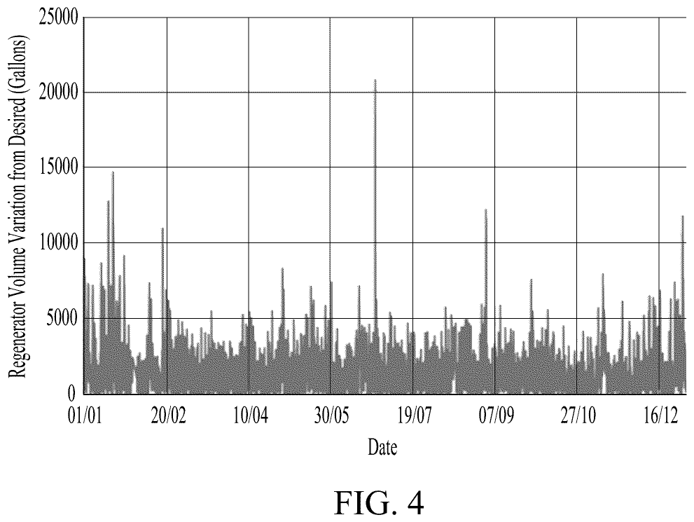

For example, the efficiency of the regenerator 110 to remove the acid gas component from the rich amine stream 14 may be primarily related to the feed rates of the various streams into the regenerator 110, which in turn may be quantified by the bottoms liquid level in the same. At greater flow rates, and in turn greater liquid levels, the stripping efficiency of the regenerator 110 may be reduced, as the up-flowing steam stream may be less efficient in removing the acid gas component from the rich amine stream 14 with the increased surrounding water content. The varying water content may be illustrated for example in FIG. 4, which shows the system volume variation in gallons per day from the desired bottoms liquid level/volume of the regenerator for the same example as FIG. 3. This variation and the reduced efficiency may in turn result in a lean amine stream 4 with amines still saturated with the acid gas component. This may in turn negatively impact the results of the amine absorption unit 102 when the lean amine stream 4 is recycled, as less of the amine is unsaturated to further absorb acid gases from the acid gas stream 2.

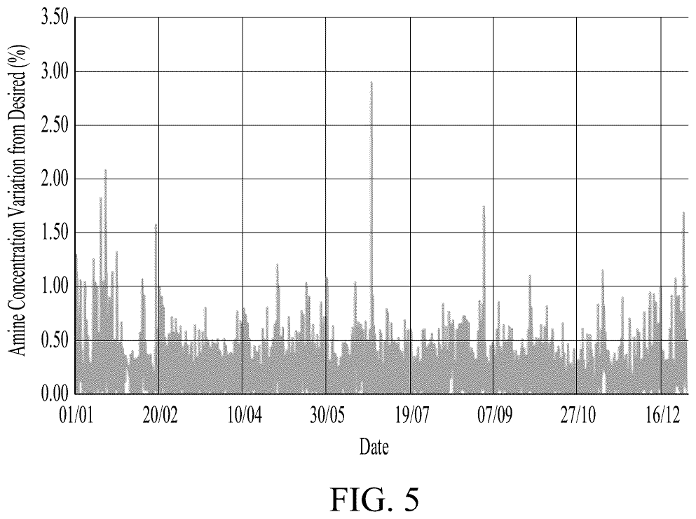

As previously described, the amines used in the process are present in an aqueous solution. Accordingly, variation in the bottoms liquid level of the regenerator 110 may in turn impact the concentration of amines within the same. As these amines are reused as the lean amine stream 4 in the amine absorption unit 102, variations in the concentration level may in turn also affect the absorption efficiency and removal of the acid gas component to form the sweet gas stream. Consequently, variations in the bottoms liquid level may negatively impact the amine absorption unit 102 in this manner. This is illustrated for example in FIG. 5, which shows the variation in amine concentration per day from the desired concentration for the same example as FIGS. 3 and 4.

Accordingly, the bottoms liquid level of the regenerator 110 should be controlled in such a manner that it remains relatively consistent, so as to avoid variations in the acid gas saturation and concentration of the amines in the lean amine stream 4. The automated system 100 may control the bottoms liquid level using the processes described supra by the controller 116 executing a process with the control valve 103, and thereby the Girbotol process 101.

The process may include monitoring a flow rate of the acid gas stream 2, the make-up water stream 6, the water washed sweet gas stream 8, the compression return stream 12, the acid gas concentrate stream 18, and the sour water stream 20, as well as the bottoms liquid level; observing a change in the flow rate of one or more of: the acid gas stream 2, the make-up water stream 6, the water washed sweet gas stream 8, the compression return stream 12, the acid gas concentrate stream 18, and the sour water stream 20; calculating an expected change in the bottoms liquid level of the regenerator 110 based on the change in the flow rate of the one or more of: the acid gas stream 2, the make-up water stream 6, the water washed sweet gas stream 8, the compression return stream 12, the acid gas concentrate stream 18, and the sour water stream 20; determining a first expected change in the make-up water stream 6's flow rate needed to offset the expected change in the bottoms liquid level of the regenerator 110; and adjusting the make-up water stream 6's flow rate by adjusting the control valve 103 based on the first expected change.

As previously described the process may include monitoring a flow rate of the make-up water stream 6, the acid gas stream 2, the compression return stream 12, and the sour water stream 20, as well as the bottoms liquid level. In embodiments, the flow rates of the make-up water stream 6, the acid gas stream 2, the compression return stream 12, the sour water stream 20, may be determined using a flowmeter or any other method of determining the flow rate of a fluid known to one of ordinary skill in the art.

As previously described, the process may further include observing a change in the flow rate of one or more of: the acid gas stream 2, the make-up water stream 6, the water washed sweet gas stream 8, the compression return stream 12, the acid gas concentrate stream 18, and the sour water stream 20.

Further, monitoring the flow rates of the streams, rather than the bottoms liquid level of the regenerator 110, may be beneficial due to the relatively closer point of introduction for streams such as the compression return stream 12 and the sour water stream 20 as compared to the make-up water stream 6, as illustrated in FIGS. 1 and 2. Accordingly, adjusting the make-up water stream 6's flow rate only after observing a change in the bottoms liquid level of the regenerator 110 would result in a delay between the change in the make-up water stream and the resulting regenerator 110 bottoms liquid level. This is undesired as the adjustment may be reacting to a change in the bottoms liquid level that may have already changed again in the delay.

Accordingly, as previously described, the process may further include a ‘feed-forward logic,’ through the controller 116, that correlates the changes in the flow rates of the streams to an expected change in the bottoms liquid volume, and thereby the bottoms liquid level, of the regenerator 110. Thereby, the process may proactively adjust to what the bottoms liquid level will be, rather than what it currently is. Particularly, the process may correlate the change in the flow rate to the change in a bottoms liquid volume of the regenerator 110 (which is directly related to the bottoms liquid level) by multiplying the respective stream's change in flow rate, denoted by Δ #, by its associated “conversion factor,” denoted as CF_{#}, wherein # denotes the stream number. For example the acid gas stream 2 may have a change in flow rate Δ2 and an associated conversion factor CF₂. The conversion factor may be dependent on a number of factors, including but not limited to the sizing of the regenerator 110 and the conversion efficiencies of the various units of the Girbotol process 101. The conversion factor may also be either positive or negative, depending on whether the streams remove water from the Girbotol process (for example, the acid gas concentrate stream 18) or introduce water into the Girbotol process 101 (for example, the sour water stream 20).

As a further part of the feed-forward logic, the controller 116 may then calculate the first expected change in the make-up water stream 6's flow rate necessary to offset the expected change in the bottoms liquid volume of the regenerator 110, and thus the expected change in the bottoms liquid level. Particularly, the controller may calculate the change in the make-up water flow rate necessary to offset the expected change in the bottoms liquid volume by dividing the expected change in the bottoms liquid volume of the regenerator 110 by the associated conversion factor for the make-up water stream 6 (CF₆). Accordingly, the necessary change to maintain the liquids bottoms volume of the regenerator 110 may regarded as follows in Equation I, wherein Δ6 denotes the expected change in the make-up water stream 6.

Δ6=(CF₂×Δ2)+(CF₁₂×Δ12)+(CF₂₀×Δ20)+(CF₈×Δ8)+(CF₁₈×Δ18) (I)

Particularly, the general correlation of the necessary change in the makeup water stream 6 volumetric flow rate (Δ6), through the expected change in the volume of the regenerator 110, is a function of the change in the volumetric flow rate in the acid gas stream 2 (Δ2), the water washed sweet gas stream 8 (Δ8), the compression return stream 12 (Δ12), the acid gas concentrate stream 18 (Δ18), and the sour water stream 20 (Δ20).

Through the communicative coupling 28, the controller 116 may then communicate the first expected change to the control valve 103. The controller 116, through the adjustment (opening or closing) of the control valve 103 may then adjust the make-up water stream 6's flow rate based on the first expected change.

Without being limited by theory, it is contemplated that the first adjustment to maintain the bottoms liquid level may require further, more minor adjustments to maintain the bottoms liquid level within a specified degree of tolerance. Accordingly, the process may further include a ‘feed-back logic,’ through the controller 116 to make these more minor adjustments. Particularly, the process may further include observing an actual change in the bottoms liquid volume of the regenerator 110 greater than 1%, such as from 1% to 5%, from 5% to 10%, from 10% to 50%, from 50% to 100%, or any combination of ranges or smaller range therein.

The process may then further include determining a second expected change in the make-up water stream 6's flow rate needed to offset the actual change in the bottoms liquid volume of the regenerator 110. The correlation used to obtain the second expected change may be similar or identical to that used to obtain the first expected change in Equation II, wherein ΔV_{regenerator} is instead the actual change in the bottoms liquid volume of the regenerator 110. Through the communicative coupling 28, the controller 116 may then communicate the second expected change to the control valve 103. The controller 116, through the control valve 103, may then adjust the make-up water stream 6's flow rate based on the second expected change.

In embodiments, one or more further corrections may be necessary to the bottoms liquid level depending on if the second adjustment brought the bottoms liquid level within the specified degree of tolerance. The one or more further corrections may be similar to or identical to the adjustment in the preceding two paragraphs. For example, and in embodiments, the process may further include observing a second actual change in the bottoms liquid level of the regenerator 110 greater than 1.5%; determining a third expected change in the make-up water stream 6's flow rate needed to offset the second actual change in the bottoms liquid level of the regenerator 110; communicating the third expected change to the control valve 103; and adjusting the make-up water stream 6's flow rate through the control valve 103, based on the third expected change.

In embodiments, the make-up water stream 6's flow rate should be at least greater than the rate required to water wash the sweet gas stream. If the make-up water stream 6's flow rate is less than the required rate, undesirable levels of amines may be still be present in the sweet gas stream or the water washed sweet gas stream 8, and the result may be less amines recirculating within the Girbotol process 101. Without being limited by theory, this could negatively impact efforts to control the amine concentration and saturation in the process, as uncontrolled amounts of the amine may escape within the water washed sweet gas stream 8. Accordingly, in embodiments, a ratio of the make-up water stream 6's flow rate to the flow rate of the acid gas stream 2 may be greater than 0.02 gallons per minute (GPM) make-up water stream to 1 million standard cubic feet (mmscf/d) acid gas stream per day (0.02:1). However, depending on the conditions of the Girbotol process 101 and the composition of the acid gas stream 2, this ratio may change. In practice, the necessary ratio may be determined experimentally by sampling the water washed amine stream for amine concentration at different flowrates of the make-up water stream 6, as may be understood in the art. The ratio may then be determined at the amount of make-up stream by which the concentration of amines within the water washed amine stream is maximized, within economic limits. Accordingly, in embodiments, the ratio of the acid gas stream 2 to the make up water stream 6 may be from 0.02 to 0.1, from 0.1 to 1, from 1 to 5, or any combination of ranges or smaller range therein gallons per minute make-up water stream to 1 MMSCF/D acid gas stream.

### EXAMPLES

The various embodiments of the automated systems and processes for the maintaining the bottoms liquid level of the regenerator will be further clarified by the following example. The example is illustrative in nature, and should not be understood to limit the subject matter of the present disclosure.

An iteration of the process was conducted utilizing a simulation program modeling the system and Girbotol process illustrated in FIG. 1. In the system, an acid gas stream with an acid gas content of approximately 12% (CO₂ and H₂S) was first processed in an amine absorption unit according to embodiments herein. The sweet gas stream was then subjected to the make-up water stream to form the water washed sweet gas stream and the water washed amine stream, the water washed amine stream combining with the rich amine stream. The water washed sweet gas stream exited the amine absorption unit. The water washed sweet gas stream was then processed in the scrubbing unit to form the compression return stream. The rich amine stream and the compression return stream were then processed in the flash drum to form the flashed rich amine stream. The flashed rich amine stream was then sent to the regenerator. The flashed rich amine stream and the reflux drum effluent stream were then subjected to the up-flowing steam stream to form the stripped acid gas stream, with the residual rich amine stream setting in the bottoms of the regenerator as the lean amine stream. The stripped acid gas stream and sour water stream were then processed in the reflux drum form the sour gas concentrate stream and the reflux drum effluent stream. The sour gas concentrate stream was then processed in the second scrubbing unit to form the sour water stream.

To test the process, changes in the flow rates of the acid gas stream, compression return stream, acid gas concentrate stream, and sour water stream were then simulated. The conversion factors, unit volumes, initial flow rates, and adjusted flow rates are as follows in Table 1.

TABLE 1
Flow Rates and Conversion Factors for Example

| | Initial | | Adjusted | Conversion |
|---|---|---|---|---|
| Stream | Flow Rate | | Flow Rate | Factor |
| Acid Gas Stream | 250 | Mmscf/d | no change | 0.01 |
| Make-Up Water Stream | 13 | GPM | NA | NA |
| Water Washed Sweet Gas | 230 | mmscf/d | no change | 0.02 |
| Stream | | | | |
| Compression Return Stream | 5 | GPM | no change | 0.9 |
| Acid Gas Concentrate | 37 | mmscf/d | no change | 0.1 |
| Stream | | | | |
| Sour Water Stream | 2 | GPM | 4 GPM | −0.75 |

Accordingly, the expected required change in the makeup water flow to keep a constant regenerator bottoms liquid level was predicted as a reduction of 3 GPM, according to Equation 1. The make-up water stream was then adjusted through the control valve by the expected required change, and confirmed through stabilization of the bottoms liquid volume of the regenerator.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is also noted that recitations herein of “at least one” component, element, etc., should not be used to create an inference that the alternative use of the articles “a” or “an” should be limited to a single component, element, etc.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. An automated system for maintaining a bottoms liquid level of a regenerator in a Girbotol process, the system comprising:
the Girbotol process, comprising:
an amine absorption unit configured to process an acid gas stream, a make-up water stream, and a lean amine stream to form a sweet gas stream and a rich amine stream, wherein the amine absorption unit further comprises a control valve configured to receive the make-up water stream,
a flash drum fluidly connected to and downstream from the amine absorption unit and configured to process the rich amine stream and a compression return stream to form a flashed rich amine stream,
the regenerator fluidly connected to and downstream from the flash drum, fluidly connected to and upstream from the amine absorption unit, and configured to process the flashed rich amine stream and a reflux drum effluent stream to form a stripped acid gas stream and the lean amine stream comprising amines in a aqueous solution, and
a reflux drum fluidly connected to and downstream from the regenerator and configured to process the stripped acid gas stream and a sour water stream to form an acid gas concentrate stream and the reflux drum effluent stream; and
a controller communicatively coupled to the Girbotol process and operable to execute a process with the control valve, the process comprising:
monitoring a flow rate of the acid gas stream, water washed sweet gas stream, the compression return stream, the acid gas concentrate stream, the sour water stream, and the make-up water stream,
observing a change in the flow rate of the acid gas stream, water washed sweet gas stream, the compression return stream, the acid gas concentrate stream, the sour water stream, or combinations thereof,
calculating an expected change in a bottoms liquid volume of the regenerator based on the change in the flow rate of the one or more of: the acid gas stream, water washed sweet gas stream, the compression return stream, the acid gas concentrate stream, and the sour water stream,
determining a first expected change in the make-up water stream's flow rate needed to offset the expected change in the bottoms liquid volume of the regenerator, and
adjusting the make-up water stream's flow rate through the control valve, based on the first expected change.

2. The system of claim 1, wherein the process further comprises:
observing an actual change in the bottoms liquid volume of the regenerator greater than 1% of the original bottoms liquid volume;
determining a second expected change in the make-up water stream's flow rate needed to offset the actual change in the bottoms liquid volume of the regenerator; and
adjusting the make-up water stream's flow rate through the control valve based on the second expected change.

3. The system of claim 2, wherein the process further comprises:
observing a second actual change in the bottoms liquid volume of the regenerator greater than 1.5% of the original bottoms liquid volume;
determining a third expected change in the make-up water stream's flow rate needed to offset the second actual change in the bottoms liquid volume of the regenerator; and
adjusting the make-up water stream's flow rate through the control valve based on the third expected change.

4. The system of claim 1, wherein the amine absorption unit comprises an amine absorption section and a water washing section in fluid communication with and disposed above the amine absorption section.

5. The system of claim 4, wherein:
the amine absorption section is configured to process the acid gas stream with the lean amine gas stream to generate the rich amine stream and the sweet gas stream; and
the water washing section is configured to expose the sweet gas stream to the make-up water stream to form a water washed sweet gas stream and additional rich amine stream.

6. The system of claim 5, wherein the water washed sweet gas stream comprises a relatively lesser amount of amines than the sweet gas stream.

7. The system of claim 6, wherein a ratio of the adjusted make-up water stream's flow rate to the flow rate of the sweet gas stream is greater than 0.02 gallons per minute (GPM) make-up water stream to 1 million standard cubic feet per day (MMSCF/D) acid gas stream.

8. The system of claim 1, wherein the flow rates of the make-up water stream, the acid gas stream, the compression return stream, and the sour water stream, are determined using a flowmeter.

9. The system of claim 1, further comprising a re-boiler unit fluidly connected to the regenerator, wherein:
the regenerator is further configured to form a regenerator effluent stream comprising water;
the re-boiler unit is configured to heat the regenerator effluent stream to form a water vapor stream; and
the re-boiler is further configured to send the water vapor stream to the regenerator to form additional stripped acid gas stream and additional lean amine stream.

10. The system of claim 1, wherein:
the amine absorption section is configured to process the acid gas stream with the lean amine gas stream to generate the rich amine stream and a sweet gas stream comprising amines;
the water washing section is configured to expose the make-up water stream to the sweet gas stream to form a water washed sweet gas stream and additional rich amine stream;
the water washed sweet gas stream comprises a relatively lesser amount of amines than the sweet gas stream.
a ratio of the adjusted make-up water stream's flow rate to the flow rate of the sweet gas stream is greater than greater than 0.02 gallons per minute (GPM) make-up water stream to 1 million standard cubic feet per day (MMSCF/D) acid gas stream;
the regenerator is further configured to form an amine concentrate stream comprising greater than 50 wt. % amines and less than 50 wt. % acid gas;
the regenerator further comprises a re-boiler unit configured to process the amine concentrate stream to form an acid gas vapor stream and the lean amine stream; and
the re-boiler is further configured to send the acid gas vapor stream to be recycled in the regenerator to produce additional stripped acid gas stream.

11. The system of claim 10, wherein the process further comprises:
observing an actual change in the bottoms liquid volume of the regenerator greater than 1%;
determining a second expected change in the make-up water stream's flow rate needed to offset the actual change in the bottoms liquid volume of the regenerator;
adjusting the make-up water stream's flow rate based on the second expected change;
observing a second actual change in the bottoms liquid volume of the regenerator greater than 1.5%;
determining a third expected change in the make-up water stream's flow rate needed to offset the second actual change in the bottoms liquid volume of the regenerator; and
adjusting the make-up water stream's flow rate through the control valve based on the third expected change.

12. An automated process for maintaining a bottoms liquid volume of a regenerator in a Girbotol process, wherein:
the Girbotol process comprises:
an amine absorption unit configured to process an acid gas stream, a make-up water stream, and a lean amine stream to form a sweet gas stream and a rich amine stream, wherein the amine absorption unit further comprises a control valve configured to receive the make-up water stream,
a flash drum fluidly connected to and downstream from the amine absorption unit and configured to process the rich amine stream and a compression return stream to form a flashed rich amine stream,
the regenerator fluidly connected to and downstream from the flash drum, fluidly connected to and upstream from the amine absorption unit, and configured to process the flashed rich amine stream and a reflux drum effluent stream to form a stripped acid gas stream and the lean amine stream comprising amines in an aqueous solution, and
a reflux drum fluidly connected to and downstream from the regenerator and configured to process the stripped acid gas stream and a sour water stream to form an acid gas concentrate stream and a reflux drum effluent stream; and
the process comprises:
monitoring a flow rate of the acid gas stream, water washed sweet gas stream, the compression return stream, the acid gas concentrate stream, the sour water stream, and the make-up water stream,
observing a change in the flow rate of the acid gas stream, water washed sweet gas stream, the compression return stream, the acid gas concentrate stream, the sour water stream, or combinations thereof,
calculating an expected change in the bottoms liquid volume of the regenerator based on the change in the flow rate of the one or more of: the acid gas stream, water washed sweet gas stream, the compression return stream, the acid gas concentrate stream, and the sour water stream;
determining a first expected change in the make-up water stream's flow rate needed to offset the expected change in the bottoms liquid volume of the regenerator; and
adjusting the make-up water stream's flow rate through the control valve based on the first expected change.

13. The process of claim 12, further comprising:
observing an actual change in the bottoms liquid volume of the regenerator greater than 1%;
determining a second expected change in the make-up water stream's flow rate needed to offset the actual change in the bottoms liquid volume of the regenerator; and
adjusting the make-up water stream's flow rate through the control valve based on the second expected change.

14. The process of claim 12, further comprising:
observing a second actual change in the bottoms liquid volume of the regenerator greater than 1.5%;
determining a third expected change in the make-up water stream's flow rate needed to offset the second actual change in the bottoms liquid volume of the regenerator; and
adjusting the make-up water stream's flow rate through the control valve based on the third expected change.

15. The process of claim 12, wherein the amine absorption unit comprises an amine absorption section and a water washing section in fluid communication with and disposed above the amine absorption unit.

16. The process of claim 15, wherein:
the amine absorption section is configured to process the acid gas stream with the lean amine gas stream to generate the rich amine stream and a sweet gas stream comprising amines; and
the water washing section is configured to expose the make-up water stream to the sweet gas stream to form the sweet gas stream and additional rich amine stream.

17. The process of claim 16, wherein the water washed sweet gas stream comprises a relatively lesser amount of amines than the sweet gas stream.

18. The process of claim 16, wherein a ratio of the adjusted make-up water stream's flow rate to the flow rate of the sweet gas stream is greater than greater than 0.02 gallons per minute (GPM) make-up water stream to 1 million standard cubic feet per day (MMSCF/D) acid gas stream.

19. The process of claim 12, wherein the flow rates of make-up water stream, the acid gas stream, the compression return stream, the sour water stream, and the make-up water stream are determined using a flowmeter.

20. The process of claim 12, wherein:
the Girbotol process further comprises a re-boiler unit fluidly connected to the regenerator;
the regenerator is further configured to form a regenerator effluent stream comprising water;
the re-boiler unit is configured to heat the regenerator effluent stream to form a water vapor stream; and
the re-boiler is further configured to send the water vapor stream to the regenerator to form additional stripped acid gas stream and additional lean amine stream.
